(19) United States
(12) Patent Application Publication
(10) Pub. No.: US 2026/0055300 A1
(43) Pub. Date: Feb. 26, 2026

(54) COMPOSITIONS FOR PROTECTING AND/OR REJUVENATING BUILDING COVERING MATERIALS

(71) Applicant: Les Produits GO NANO inc., Mirabel (CA)

(72) Inventor: Jonathan DUQUETTE, Mirabel (CA)

(21) Appl. No.: 18/812,500

(22) Filed: Aug. 22, 2024

(51) Int. Cl. C09D 191/00; C09D 7/20; C09D 7/40; C09D 7/63

(52) U.S. Cl. CPC C09D 191/005; C09D 7/20; C09D 7/63; C09D 7/67

(57) ABSTRACT

A composition, which can prevent or and/or reverse age-associated damage to a building covering material (e.g., shingles or roof membranes). The composition includes a base including an organic solvent and nanoparticles, and a bio-based oil, wherein the composition includes an amount of the bio-based oil and of the base in a wt.:wt. ratio of from about 20:80 to about 50:50, and wherein the composition is adapted for application on a surface of the building covering material.

### TECHNICAL FIELD

This application generally relates to the field of compositions for protecting and/or rejuvenating building covering materials, in particular roof or façade covering materials such as shingles and roof membranes, as well as methods of using and of manufacturing such compositions.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

A roof covering of a building is the exterior part of the roof, designed to endure all weather conditions such as rain, snow, hail, and wind. A facade is generally the front part or exterior of a building. The roof covering can include shingles or a roof coating (e.g., a roof membrane), which are designed to provide protection to such weather conditions. The façade can also include shingles. Shingles are composed of individual overlapping elements, typically flat and rectangular, arranged in rows from the bottom edge of the roof or façade upward. Each successive row overlaps the joints of the row below. Shingles can be made from a variety of materials, including wood, slate, flagstone, metal, plastic and composite materials such as fiber cement and asphalt. Roof coatings are most commonly made from acrylics, asphalt, butyl, coal tar pitch, polyurea, polyurethanes, polyvinylidene fluoride, silicones, or styrene-butadiene.

Over time, exposure to outdoor environments can lead to cracking or puncture damage on shingles or membranes, particularly from impact forces caused by hailstorms. Products designed to prevent and/or reverse age-associated damage to shingles or membranes (e.g., embrittlement, cracking, or puncture damage) are critical for extending the service life of these materials. These products can reduce the cost of ownership and decrease waste generation.

Several compositions have been proposed to prevent and/or reverse age-associated damage to shingles or membranes. For instance, highly viscous materials have been suggested to adhere to the existing shingles or membrane, forming an additional protective layer against weather. These materials include compositions comprising epoxidized or partially epoxidized triglycerides, non-asphaltic-based coatings or emulsions, polymer-modified-asphalt-based coatings or emulsions, plasticizers, aqueous silicone elastomers, water-based polymeric emulsions, resins, and rheology modifiers. Examples of such compositions are described in at least the following U.S. Pat. Nos. 4,571,415, 4,859,723, 5,434,009, and 8,058,342, and in at least the following U.S. Patent Publications: 2022/0112130, 2024/0102289, and 2020/014891. These types of compositions typically cover the existing shingles or membrane, which may destroy any aesthetic value of the roof or façade, such as architectural shingles.

In light of the above, there is a need to provide improved compositions and methods that alleviate at least in part the deficiencies of the existing compositions to protect and/or rejuvenate building covering materials.

### SUMMARY

This Summary is provided to introduce a selection of concepts in a simplified form that are further described below in the Detailed Description. This Summary is not intended to identify key aspects or essential aspects of the claimed subject matter.

As embodied and broadly described herein, the present disclosure relates to a composition for preventing and/or reversing age-associated damage to a building covering material, comprising a base including an organic solvent and nanoparticles, and a bio-based oil, wherein the composition includes an amount of the bio-based oil and of the base in a wt.: wt. ratio of from about 20:80 to about 50:50, and wherein the composition is adapted for application on a surface of the building covering material.

As embodied and broadly described herein, the present disclosure relates to a manufacturing method comprising providing a base containing an organic solvent with nanoparticles, and mixing the base with a bio-based oil to obtain a composition, wherein the composition includes an amount of the bio-based oil and of the base in a wt.: wt. ratio of from about 20:80 to about 50:50, and wherein the composition is adapted for application on a surface of a building covering material for preventing and/or reversing age-associated damage to the building covering material.

As embodied and broadly described herein, the present disclosure relates to a method comprising providing a composition including a base including an organic solvent and nanoparticles, and a bio-based oil, wherein the composition includes an amount of the bio- based oil and of the base in a wt.: wt. ratio of from about 20:80 to about 50:50, and applying the composition on a surface of a building covering material for preventing and/or reversing age- associated damage to the building covering material.

All features of exemplary embodiments which are described in this disclosure and are not mutually exclusive can be combined with one another. Elements of one embodiment can be utilized in the other embodiments without further mention. Other aspects and features of the present invention will become apparent to those ordinarily skilled in the art upon review of the following description of specific embodiments in conjunction with the accompanying Figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

A detailed description of specific exemplary embodiments is provided herein below with reference to the accompanying drawings in which:

FIG. 1 is a non-limiting flowchart that illustrates a method to prevent and/or reverse damage to building covering materials, in accordance with embodiments of the present disclosure.

FIG. 2 is a non-limiting flowchart that illustrates exemplary steps for providing the composition of FIG. 1, in accordance with embodiments of the present disclosure.

FIG. 3 is a non-limiting flowchart that illustrates exemplary steps for preparing the composition of FIG. 2, in accordance with embodiments of the present disclosure.

FIG. 4 is a non-limiting illustration depicting the method of FIGS. 1-3, in accordance with embodiments of the present disclosure.

FIG. 5 is a non-limiting FITR analysis of a base containing organosilicon nanoparticles.

FIG. 6 is a non-limiting FITR analysis of asphalt shingles treated with a base containing nanoparticles and asphalt shingles treated with the base without nanoparticles.

FIG. 7 is a non-limiting FITR analysis of control asphalt-containing shingles, namely from top to bottom: black, green, blue and brown shingles.

FIG. 8 is a non-limiting FITR analysis of the control black shingle from FIG. 7 and of same black shingle coated with: (01A) composition containing an organic solvent and 50 wt. % soybean oil, (01B) composition containing an organic solvent, 30 wt. % organosilicon nanoparticles and 50 wt. % soybean oil, (01C) composition containing an organic solvent, 20 wt. % gilsonite, 20 wt. % soybean oil, and 30 wt. % organosilicon nanoparticles.

FIG. 9 is a non-limiting FITR analysis of the control green shingle from FIG. 7 and same green shingle coated with: (01A) composition containing an organic solvent and 50 wt. % soybean oil, (01B) composition containing an organic solvent, 30 wt. % organosilicon nanoparticles and 50 wt. % soybean oil, (01C) composition containing an organic solvent, 20 wt. % gilsonite, 20 wt. % soybean oil, and 30 wt. % organosilicon nanoparticles.

FIG. 10 is a non-limiting FITR analysis of the control blue shingle from FIG. 7 and same blue shingle coated with: (01A) composition containing an organic solvent and 50 wt. % soybean oil, (01B) composition containing an organic solvent, 30 wt. % organosilicon nanoparticles and 50 wt. % soybean oil, (01C) composition containing an organic solvent, 20 wt. % gilsonite, 20 wt. % soybean oil, and 30 wt. % organosilicon nanoparticles.

FIG. 11 is a non-limiting FITR analysis of the control brown shingle from FIG. 7 and same brown shingle coated with: (01A) composition containing an organic solvent and 50 wt. % soybean oil, (01B) composition containing an organic solvent, 30 wt. % organosilicon nanoparticles and 50 wt. % soybean oil, (01C) composition containing an organic solvent, 20 wt. % gilsonite, 20 wt. % soybean oil, and 30 wt. % organosilicon nanoparticles.

FIG. 12 is a non-limiting FITR analysis of the control black shingle from FIG. 7 and of same black shingle coated with: (F4) composition containing organic solvent and 60 wt. % organosilicon nanoparticles, (F5) composition containing an organic solvent, 30 wt. % organosilicon nanoparticles, and 20 wt. % soybean oil, (F6) composition containing an organic solvent, 10 wt. % gilsonite, 30 wt. % organosilicon nanoparticles, and 20 wt. % soybean oil.

FIG. 13 is a non-limiting FITR analysis of the control green shingle from FIG. 7 and of same green shingle coated with: (F4) composition containing an organic solvent and 60 wt. % organosilicon nanoparticles, (F5) composition containing organic solvent, 20 wt. % organosilicon nanoparticles, and 20 wt. % soybean oil, (F6) composition containing organic solvent, 10 wt. % gilsonite, 20 wt. % organosilicon nanoparticles, and 20 wt. % soybean oil.

FIG. 14 is a non-limiting FITR analysis of a blue shingle from FIG. 7 and of same blue shingle coated with: (F4) composition containing an organic solvent and 60 wt. % organosilicon nanoparticles, (F5) composition containing an organic solvent, 30 wt. % organosilicon nanoparticles, and 20 wt. % soybean oil, (F6) composition containing an organic solvent, 10 wt. % gilsonite, 30 wt. % organosilicon nanoparticles, and 20 wt. % soybean oil.

FIG. 15 is a non-limiting FITR analysis of a brown shingle from FIG. 7 and of same brown shingle coated with: (F4) composition containing an organic solvent and 60 wt. % organosilicon nanoparticles, (F5) composition containing an organic solvent, 30 wt. % organosilicon nanoparticles, and 20 wt. % soybean oil, (F6) composition containing an organic solvent, 10 wt. % gilsonite, 30 wt. % organosilicon nanoparticles, and 20 wt. % soybean oil.

FIG. 16A is a non-limiting picture of a set up for an impact test, in accordance with embodiments of the present disclosure.

FIG. 16B is a non-limiting picture of a ball for use in the impact test of FIG. 16A, in accordance with embodiments of the present disclosure.

FIG. 17 is a non-limiting picture of, from left to right, the control green shingle, blue shingle, black shingle, and brown shingle of FIG. 7.

FIG. 18 is a non-limiting picture of the control shingles of FIG. 17, which have been submitted to the impact test at 10 feet.

FIG. 19 is a non-limiting picture of the shingles of FIG. 17, which have been treated with composition 1 and which have been submitted to the impact test at 10 feet.

FIG. 20 is a non-limiting picture of the shingles of FIG. 17, which have been treated with composition 2 and which have been submitted to the impact test at 10 feet.

FIG. 21 is a non-limiting picture of the shingles of FIG. 17, which have been treated with composition 3 and which have been submitted to the impact test at 10 feet.

FIG. 22 is a non-limiting picture of the shingles of FIG. 17, which have been treated with composition 4 and which have been submitted to the impact test at 10 feet.

FIG. 23 is a non-limiting picture of the shingles of FIG. 17, which have been treated with composition 5 and which have been submitted to the impact test at 10 feet.

FIG. 24 is a non-limiting picture of the shingles of FIG. 17, which have been treated with composition 6 and which have been submitted to the impact test at 10 feet.

FIG. 25 is a non-limiting picture of a wind resistance test of shingles treated with a composition containing an organic solvent and nanoparticles, and tested at 90 mph, in accordance with embodiments of the present disclosure.

FIG. 26 is a non-limiting picture of a wind resistance test of shingles treated with a composition containing an organic solvent and nanoparticles, and tested at 110 mph, in accordance with embodiments of the present disclosure.

FIG. 27A is a non-limiting picture of a control shingle of 15 years of age.

FIG. 27B is a non-limiting picture of a similar 15 year old shingle as that one of FIG. 27A treated with a composition containing a base (an organic solvent and nanoparticles) and a soybean oil in a ratio of 50:50.

FIG. 27C is a non-limiting picture of the shingle of FIG. 27A with water spilled thereon.

FIG. 27D is a non-limiting picture of the shingle of FIG. 27B with water spilled thereon.

FIG. 28A is a non-limiting picture of a control new shingle.

FIG. 28B is a non-limiting picture of a similar new shingle as that one of FIG. 28A treated with a composition containing a soybean oil and a base (an organic solvent and nanoparticles) at a ratio 20:80.

FIG. 28C is a non-limiting picture of the shingle of FIG. 28A with water spilled thereon.

FIG. 28D is a non-limiting picture of the shingle of FIG. 28B with water spilled thereon.

FIGS. 29A-29B are non-limiting pictures a new control shingle and of similar new shingle treated with a composition containing a 20:80 mixture of the soybean oil and base.

FIGS. 30A-30B are non-limiting pictures of an old control shingle and of similar old shingle treated with a composition containing a 50:50 mixture of the base and soybean oil.

In the drawings, exemplary embodiments are illustrated by way of example. It is to be expressly understood that the description and drawings are only for the purpose of illustrating certain embodiments and are an aid for understanding. They are not intended to be a definition of the limits of the invention.

### DETAILED DESCRIPTION

The present technology is explained in greater detail below. This description is not intended to be a detailed catalog of all the different ways in which the technology may be implemented, or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art considering the instant disclosure which variations and additions do not depart from the present technology. Hence, the following description is intended to illustrate some embodiments of the technology, and not to exhaustively specify all permutations, combinations, and variations thereof.

The present inventor has through R&D work surprisingly and unexpectedly designed and produced a composition, which can prevent or and/or reverse age-associated damage to a building covering material (e.g., shingles or roof membranes). The composition of the present disclosure addresses at least some of the known compositions shortcomings. The composition of the present disclosure includes an organic solvent, a bio-based oil (or blend thereof) and nanoparticles, which afford a technical effect that is believed to not have been foreseeable from the known and existing roof or façade coating compositions.

Without being bound by any theory, it is believed that the composition of the present disclosure affords such technical effect through the combined action of the nanoparticles and bio-based oil. For example, it is believed that the nanoparticles penetrate the material surface, filling cracks and voids, and creating new chemical bonds, resulting in a dense and compact structure with reduced capillary porosity to enhance durability, preventing water and chemical intrusion that can cause further damage. For example, it is believed that the bio-based oil promotes rejuvenation, improving flexibility and resilience flexibility, enabling the material to withstand temperature fluctuations, thermal stress, and structural movements without cracking or becoming brittle. It is believed that the nanoparticles enhance the penetration of the bio- based oil into the material surface, which provides (i) an improved protective barrier that fortifies the material against weathering, UV radiation, and aging, (ii) preserves the building's aesthetics, such as color and texture, and (iii) in the case of aged material, restores flexibility and provides additional resistance to creasing, tearing, cracking, or splitting. Such a technical effect of enhancing the penetration of the bio-based oil in the material surface was determined at least with FITR spectra. Such enhanced penetration was surprising and unexpected to the inventor.

### Composition

In a broad non-limiting implementation, the present disclosure relates to a composition which includes an organic solvent, nanoparticles and a bio-based oil.

It has been observed that the composition of the present disclosure creates a water- resistant barrier, reducing water penetration and mitigating the risks of leaks and roof or façade degradation caused by rain, snow, and moisture. The composition of the present disclosure thus promotes an extended lifespan for the roof or façade, saving costs associated with replacements or repairs, while preserving building's aesthetics, such as color and texture. Further, the composition of the present disclosure can incorporate renewable and biodegradable bio-based oils, thus reducing reliance on petroleum-based additives and promoting eco-conscious practices. Further, the composition of the present disclosure is relatively easy to apply using standard equipment, e.g., sprayers or brushes, spreading evenly, and has a reasonable drying and curing time, allowing it to set properly without being washed away by rain or other environmental factors.

In some implementations, the composition of the present disclosure may have a viscosity which is moderate, allowing for easy application by spraying or brushing. It should be low enough to penetrate surfaces effectively but high enough to form a protective layer, when desired. For example, the viscosity can be measured according to ASTM D562: Standard Test Method for Consistency of Paints Measuring Krebs Unit (KU) Viscosity Using a Stormer-Type Viscometer. A viscosity of the composition of about 100-140 KU, preferably about 125-135 KU, is particularly adapted for spraying application.

In some implementations, the composition of the present disclosure includes a suitable solvent, for example an organic solvent. Preferably, the solvent is compatible with the nanoparticles and the bio-based oil. More preferably, the solvent also has a low volatile organic content (VOC) content, namely that is at or below 150 g/L. More preferably, the solvent is exempt from VOC.

In some implementations, the solvent can be hydrotreated light distillate (CAS No. 64742-47-8), mineral spirits (stoddard solvent), isoparaffinic hydrocarbons (e.g., isopar), citrus terpenes (e.g., D-limonene), low aromatic white spirits, naphta, glycol ether (e.g., Diethylene Glycol Monoethyl Ether (DEGEE), Dipropylene Glycol Monomethyl Ether (DPM), Propylene Glycol Methyl Ether Acetate (PGMEA), and the like), Dimethyl Carbonate (DMC), Methyl Acetate, parachlorobenzotrifluoride (PCBTF), acetone, Butyl Acetate, tert-Butyl Acetate (TBAc), 2-Methyl-4-pentanone (MIBK), ethyl lactate, ionic liquids, and the like. Preferably, the solvent is hydrotreated light distillate.

In some implementations, the composition of the present disclosure includes a bio-based oil. The reader will readily understand that a blend of bio-based oils is also envisioned.

When the roof or facade of a building ages, petrochemical oils evaporate from asphalt- containing surface material, leading to these materials drying out, losing their elasticity, crumbling, and eventually leaking. Such age-related degradation is particularly damaging for asphalt-containing shingles or bitumen-derived roof membranes. Without being bound by any theory, it is believed that bio-based oils are effective in protecting and/or rejuvenating asphalt- containing or bitumen-derived surface material by several means. These oils can penetrate the surface material, likely due to their low viscosity. Inside the surface material, they are believed to soften the asphalt binder by interacting with its long-chain hydrocarbons, which can reverse the brittleness induced from weather exposure, thus restoring flexibility. These oils are also believed to replenish the evaporated petrochemical oils, while improving the adhesion between the asphalt binder and the aggregate, and forming a protective layer from UV radiation and moisture.

For example, the bio-based oil may have a high flash point temperature above 93° C., which is suitable for safety and environmental concerns, as determined by Flash Point: AASHTO T48-06 or ASTM D92-05a. A liquid with a flash point above 93 Celsius degrees does not meet GHS classification criteria and will not be regarded as a hazardous chemical.

For example, the composition may include from about 20 wt. % to about 50 wt. % of the bio-based oil (or blend of bio-based oils), including any values or ranges therein. For example, the composition may include the bio-based oil in an amount of about 20 wt. %, about 25 wt. %, about 30 wt. %, about 35 wt. %, about 40 wt. %, about 45 wt. %, or about 50 wt. %.

For example, the bio-based oil may be a vegetable oil. Non-limiting examples of vegetable oil include linseed oil, olive oil, peanut oil, corn oil, palm oil, canola oil, soybean oil, or tall oil, or a blend thereof. For example, a preferred bio-based oil may be soybean oil. For example, a preferred bio-based oil may be soy methyl ester (SME). SME is obtained through the transesterification of soybean oil, and offers a non-toxic and biodegradable substitute for petroleum-based solvents. For example, a blend of bio-based oils can include SME and epoxidized soybean oil (ESO).

In some implementations, the composition of the present disclosure further includes nanoparticles.

For example, the nanoparticles may have an average particle size of from about 10 nm to about 100 nm, including any values or ranges therein. For example, an average particle size of from about 10 nm to about 50 nm, preferably from about 20 nm to about 30 nm. For example, an average particle size of about 10 nm, about 20 nm, about 25 nm, about 30 nm, about 40 nm, or about 50 nm. Preferably, the majority of particles should fall within ±10% of the average particle size.

For example, the nanoparticles may have a surface area of from about 50 m²/g to about 200 m²/g, determined using Brunauer-Emmett-Teller (BET) analysis.

For example, the nanoparticles may have a spherical or nearly spherical shape for a more uniform dispersion in the composition.

For example, the nanoparticles may include any one of nano-silica, nano-titania, carbon nanotubes, organosilicon nanoparticles, nanoclay, graphene nanoplatelets, and nano-alumina particles, or any mixture thereof. For example, the nanoparticles can be nano-silica particles, which may be silane-treated with one or more silane coupling agents to obtain an organosilane modified nano-silica for improved dispersion in organic phases. For example, the silane coupling agent can include Vinyltrimethoxysilane or Aminopropyltriethoxysilane. Preferably, the nanoparticles are organosilicon nanoparticles.

For example, the organosilicon nanoparticles can be one or more of octamethylcyclotetrasiloxane (CAS No. 556-67-2), trimethoxyoctylsilane (CAS No. 3069-40-7), (7-oxabicyclo[4.1.0]heptan-4-yl) silane (CAS No. 10217-34-2), and [diacetyloxy(propyl)sily1] (CAS No. 17865-07-5). Preferably, the composition includes a mixture thereof.

For example, the composition may include an amount of nanoparticles of from about 5 wt. % to about 30 wt. %, including any values or ranges therein. For example, an amount of nanoparticles of from about 5 wt. % to about 10 wt. %, or from about 10 wt. % to about 20 wt. %, or from about 15 wt. % to about 25 wt. %. For example, an amount of nanoparticles of about 5 wt. %, about 10 wt. %,, about 15 wt. %, about 20 wt. %, about 25 wt. %, or about 30 wt. %. For example, when the composition includes a blend of nanoparticles, one species of nanoparticles may be present in a respective amount which can be the same or different from another species in the blend.

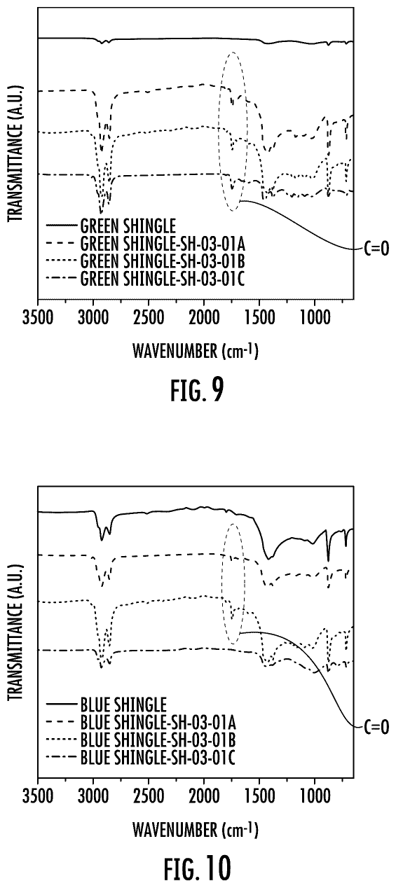

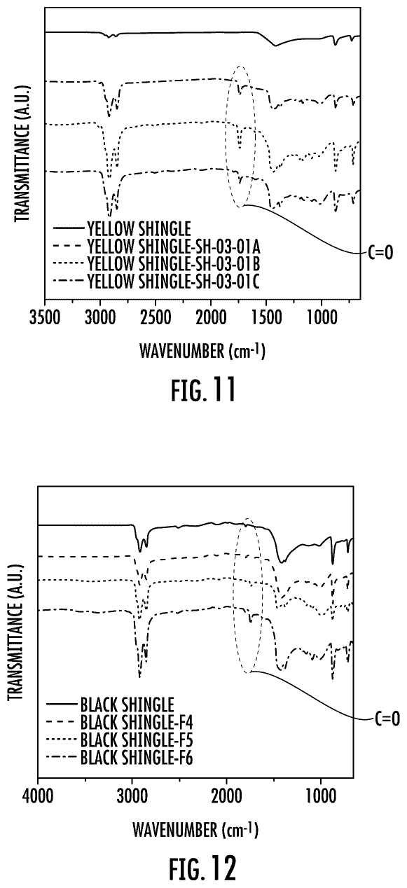

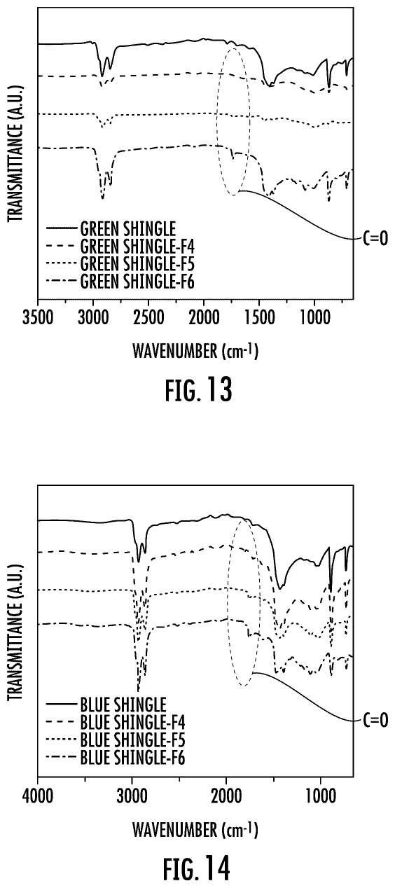

Without being bound by any theory, it is believed that the nanoparticles penetrate the roof or façade surface, filling cracks and voids, resulting in a dense and compact structure with reduced capillary porosity to enhance durability, preventing water and chemical intrusion that can cause further damage, and further enhance penetration and/or retention of the bio-based oil into the shingle or roof membrane structure. FIG. 5 shows a Fourier Transform Infrared Spectroscopy (FTIR) analysis of asphalt-containing shingle treated with a base containing an organic solvent and organosilicon nanoparticles. When the asphalt-containing shingle was treated with the base only, the surface of treated asphalt-containing shingle contained several functional groups that are present in the organosilicon nanoparticles-these nanoparticles have thus penetrated and remain within the surface of the treated shingle. FIGS. 8-15 show that the older the shingle, the less bio-based oil penetrates or remains in the shingle structure. In contrast, presence of the nanoparticles in the composition enhances the amount of bio-based oil that penetrates or remains in the shingle structure, as determined with a larger peak corresponding to the C═O bond indicative of the presence of bio-based oil within the shingle structure.

In some implementations, the composition may include an amount of bio-based oil and base (containing the nanoparticles and the organic solvent base) in a wt.:wt. ratio of from about 20:80 to about 50:50, including any values or ranges therein. For example, an amount of bio- based oil and base (containing the nanoparticles) in a wt.: wt. ratio of about 20:80, about 25:75, about 30:70, about 35:65, about 40:60, about 45:55, or about 50:50.

### Additives

In some implementations, the composition may further include one or more additives.

In some implementations, the composition may further include at least an additive such as a defoamer agent, a surfactant, a fungicide agent, an algaecide agent, a light stabilizer, an antifreeze agent, a colorant, a pigment, a light stabilizer, a UV absorber (e.g., Hindered Amine Light Stabilizers (HALS)), antioxidants (e.g., Butylated Hydroxytoluene) or a mixture thereof.

In some implementations, the composition may further include at least additional nanoparticles, such as Titanium Dioxide Nanoparticles (TiO₂) for UV protection and as a whitening agent; Zinc Oxide Nanoparticles (ZnO) as a UV absorber and providing resistance to microbial growth, which can be beneficial in preventing moss or algae formation on shingles; Alumina Nanoparticles (Al₂O₃) to enhance mechanical strength and abrasion resistance; Silica Nanoparticles (SiO₂) as a reinforcing filler and to improve barrier properties, and improve the mechanical properties of the asphalt, such as tensile strength and flexibility, while also enhancing resistance to moisture penetration; Graphene Nanoplatelets to enhance mechanical properties and thermal stability, which can be leveraged to create highly durable and weather- resistant coatings for shingles; Carbon Black Nanoparticles as a reinforcing filler and UV stabilizer, reducing degradation due to sunlight exposure; Nano-Copper Particles which provides antimicrobial properties and acts as a biocide to prevent the growth of algae, moss, and lichen on shingles, contributing to the longevity and aesthetic maintenance of roofing materials; Clay Nanoparticles (e.g., Montmorillonite) as a barrier enhancer and to improve thermal stability to improve the impermeability and thermal resistance, reducing the effects of weathering and thermal cycling; Calcium Carbonate Nanoparticles (CaCO₃) as a filler to improve mechanical properties and reduce costs, enhancing the rigidity and dimensional stability of the material while being a cost-effective additive; Boron Nitride Nanoparticles for thermal management and as a lubricant,, reducing the likelihood of heat-induced cracking; Calcium Silicate Nanoparticles to reinforce mechanical strength and provide thermal insulation; Nano-Silver Particles to provide antimicrobial and biocidal properties to prevent the growth of mold, mildew, and algae, which can otherwise degrade shingles over time; polyhedral Oligomeric Silsesquioxane (POSS) Nanoparticles to enhance thermal stability, mechanical properties, and chemical resistance; Cellulose Nanocrystals (CNCs) as a reinforcing agent to improve mechanical properties, such as improvements in tensile strength and toughness, while also contributing to the environmental sustainability of the product, and the like.

In some implementations, the composition may further include a thickener or rheology modifier to adjust the viscosity of the composition and allow the composition to be sprayed on a surface with a spraying gun. For example, hydrophobically modified ethylene oxide urethane (also known as hydrophobicaly modified urethane-ethoxylate or HEUR) or a solution of a urea- modified polyurethane can be used.

In some implementations, the composition may further include a defoamer agent, such as a silicone-containing defoamer. For example, the defoamer agent can be an emulsion of polyether-modified polydimethylsiloxane with hydrophobic solids.

In some implementations, the composition may further include at least one solvent such as, but not limited to Texanol™ (2,2,4-Trimethyl-1,3-pentanediol monoisobutyrate), Ethylene glycol monobutyl ether, or a mixture thereof.

In some implementations, the composition may further include at least one biocide such as fungicide, algicide (or algaecide), or the like.

In some implementations, the composition may further include at least one antifreeze agent, such as, but not limited to ethylene glycol (ethane-1,2-diol).

In some implementations, the composition may further include at least one light stabilizer, such as but not limited to hindered-amine light stabilizers (HALS).

In some implementations, the composition may further include at least one UV absorber, such as, but not limited to 2-hydroxy-phenyl-s-triazine (HPT), Timuvin® (2-[4-[(2-Hydroxy-3-dodecyloxypropyl)oxy]-2-hydroxyphenyl]-4,6-bis(2,4-dimethylphenyl)-1,3,5-triazine and 2-[4-[(2-Hydroxy-3-tridecyloxypropyl)oxy]-2-hydroxyphenyl]-4,6-bis(2,4-dimethylphenyl)-1,3,5-triazine (1-methoxy-2-propanol 15%)), or mixture thereof.

In some implementations, the composition may further include Styrene-Butadiene-Styrene (SBS), which is a thermoplastic elastomer that improves the elasticity and flexibility of the asphalt. SBS-modified asphalt is more resistant to deformation under stress and maintains better flexibility at low temperatures, reducing the likelihood of cracking in cold climates.

In some implementations, the composition may further include Polyphosphoric Acid (PPA), which is typically used as an asphalt modifier to improve the viscosity, stiffness, and high-temperature performance of asphalt binders. PPA enhances the durability of the asphalt and can be used in combination with other modifiers like SBS to improve overall performance, especially in hot climates.

In some implementations, the composition may further include Fatty Acid Methyl Esters (FAMEs) which are derived from vegetable oils or animal fats, FAMEs can act as rejuvenators and plasticizers. Similar to soy methyl ester, FAMEs can help restore the flexibility of aged asphalt, but they may offer different performance characteristics depending on their source and composition.

The reader will readily understand that such one or more additives can be present in the composition as long as there is compatibility with the nanoparticles and the bio-based oil.

### Practical Use of the Composition

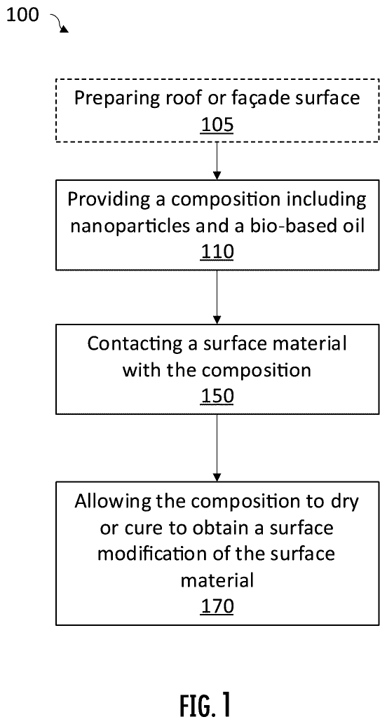

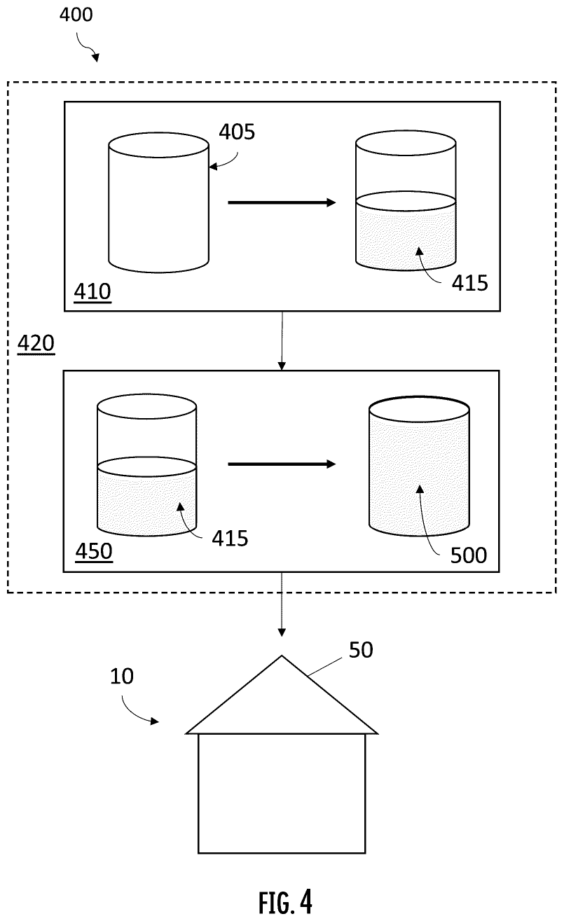

With reference to FIGS. 1 and 4, the composition 500 of the present disclosure can be used in a method 100 for obtaining a surface modification of building covering material 50, where the covering material 50 is intended for covering, or covers, a roof or facade of a building 10.

For example, the covering material 50 can be a shingle or roof membrane. For example, the shingle or roof membrane can be a new shingle or roof membrane, or can be an old shingle or roof membrane.

For example, method 100 can be implemented on a new shingle or roof membrane which has not yet been installed on the roof or facade of building 10. In such cases, implementing method 100 results in protecting against or preventing age-associated damage to the new shingle or roof membrane. In this case, method 100 can be implemented by a manufacturer, supplier and/or distributor of the new shingle or roof membrane.

For example, method 100 can be implemented on a new shingle or membrane which has been installed on the roof or facade of building 10. In such cases, implementing method 100 results in protecting against or preventing age-associated damage to the new shingle or roof membrane.

For example, method 100 can be implemented on an old shingle or membrane which has been installed on the roof or facade of building 10. In such cases, implementing method 100 results in protecting and rejuvenating the old shingle or membrane of roof or façade of building 10.

When implementing method 100 on a shingle or membrane which has been installed on the roof or facade of building 10, optionally, the roof or facade of the building to be treated is prepared before using the composition of the present disclosure. For example, when treating shingles or roof membranes 50, these can be cleaned thoroughly to remove dirt, debris, moss, and any other contaminants, and allowed to dry completely before contacting it with the composition 500 to ensure proper adhesion and penetration of the composition, at step 105. The asphalt shingles or roof membranes 50 can be present on a roof or façade of building 10.

The method 100 may include providing composition 500 which includes nanoparticles and a bio-based oil as discussed previously, step 110.

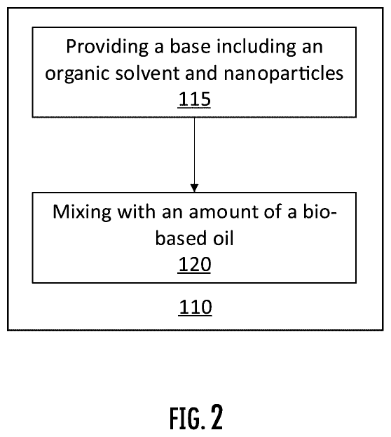

In some implementations, the composition 500 may be a ready-to-use composition, which contains all the components, or may require mixing of separate components before use. For example, one may provide a base 415 in a container 405, at step 115 as shown in FIG. 2. For example, the base 415 may include an organic solvent base and the nanoparticles. An amount of the bio-based oil can then be incorporated and mixed into the base 415, at step 120. Automated filling machines calibrated to the correct volume can be used to ensure proper volume packaging in the container 405. Optionally, the mixture of the base 415 with the bio- based oil can be homogenized to obtain a homogeneous composition.

In some instances, preparing the base 415 at step 115 and incorporating the bio-based oil at step 120 can be performed by separate manufacturing entities 410, 450 as shown in FIG. 4. Optionally, the same manufacturer entity 420 can perform both steps 115, 120.

Depending on the age deterioration level associated with the building covering material 50 to be treated, one may use one composition 500 from a set of different compositions 500. For example, when treating increasingly older building covering materials 50, one may use a composition 500 having an increased amount of bio-based oil to optimize the results and/or performance thereof. Without limiting the generality of the foregoing, it can be envisioned that when treating new shingles, the composition 500 may include an amount of bio-based oil of about 20 wt. % to obtain the desired results; when treating moderately aged shingles, the composition 500 may include an amount of bio-based oil of about 35 wt. % to obtain the desired results; and when treating heavily aged shingles, the composition 500 may include an amount of bio-based oil of about 50 wt. % to obtain the desired results.

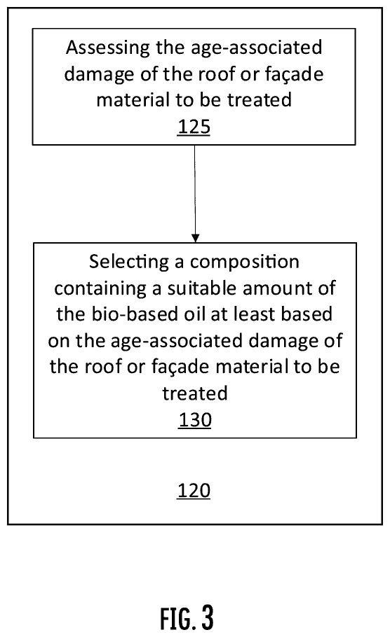

With reference to FIG. 3, method 100 may include assessing the age-associated damage of the building covering material to be treated, at step 125. At least based on such assessment, the user may then opt to select a composition 500 containing a suitable amount of the bio-based oil, at step 130. In other words, the amount of the bio-oil selected can be at least based on the age-associated damage of the building covering material to be treated.

Returning to FIG. 1, the method 100 then includes contacting the surface material 50 with the composition 500, at step 150. Such a contact step can be performed with an application of the composition 500 with any suitable means. For example, the contact step can be performed onto the surface material 50 which is already installed on the building 10 or prior to installation. For example, with a sprayer, paintbrush or roller (e.g., with synthetic bristles). Application of the composition 500 is preferably performed in such a manner to obtain an even and full coverage of the surface material 50.

The composition 500 is then allowed to dry (e.g., about 24 h) and cure (e.g., about 7-14 days) to obtain a surface modification of the surface material 50, step 170.

When applied to shingles or a roof membrane, the composition provides resistance to creasing, tearing, cracking, or splitting. This technical effect has been validated on both unrated and Class 4 asphalt shingles, demonstrating significant improvements in granular loss, creasing, tearing, cracking, or splitting resistance, and impact performance.

Impacts on asphalt shingles (e.g., from hail) can damage them. Underwriters Laboratory (UL) Standard 2218 (or the steel ball test) is a test method for evaluating impact resistance. The testing involves dropping steel balls of different diameters from varying heights onto the shingles to simulate hail pellets. When tested to UL 2218, shingles can achieve an impact-resistance rating from Class 1 through 4. Classes are determined as follows: Class 1 shingles can withstand steel balls that are 31.8 mm or 1.25 inches in diameter; Class 2 shingles can withstand steel balls that are 38.1 mm or 1.5 inches in diameter; Class 3 shingles can withstand steel balls that are 44 mm or 1.75 inches in diameter; Class 4 shingles can withstand steel balls that are 50.8 mm or 2 inches in diameter.

Class 4 is the highest level of impact resistance and indicates that under lab testing conditions, new shingles can withstand the impact from a 2-inch ball dropped from 20 feet without splitting or tearing. It is believed that application of a composition as per the present disclosure is capable of modifying the surface of a class 3 shingle so that the treated shingles behave like a class 4 shingle. In other words, suppliers can now produce class 4 shingles without having to significantly invest into their production line currently dedicated to production of class 3 shingles which investment would, otherwise, be necessary to produce class 4 shingles. It is also believed that an unrated shingle could become rated as a class 3 with one treatment and with 2 treatments to a class 4. It is also believed that a rated shingle (class 2) can become rated class 3 and a class 3 rated shingle can become a class 4 shingle with only one treatment.

### EXAMPLES

The following examples describe some exemplary modes of making and practicing certain compositions that are described herein. These examples are for illustrative purposes only and are not meant to limit the scope of the compositions and methods described herein. Further, while these compositions are tested in most of these examples with asphalt-containing shingles, however, it should be understood that the invention of the present application may be used with any type of building covering material, such as, for example, other types of roofing shingles, roof membranes, asphalt-based roll roofing, and commercial roofing.

### Example 1

In this example, a plurality of compositions are made, where the compositions for preventing and/or reversing age-associated damage to a building covering material.

The following ingredients were incorporated into a mixing vessel and thoroughly mixed at 500-1500 rpm for about 30-60 min to obtain a homogeneous and uniform base.

TABLE 1

| | | No. 1 | No. 2 | No. 3 |
|---|---|---|---|---|
| Ingredient | Example | wt. % | wt. % | wt. % |
| Base | Hydrotreated | 30-40 | 30-40 | 30-40 |
| | light distillate | | | |
| Nanoparticle | Octamethyl- | 5-10 | 5-10 | 5-10 |
| | cyclotetrasiloxane | | | |
| | Trimethoxyoctylsilane | 10-20 | 10-20 | 10-20 |
| | (7-oxabicyclo[4.1.0]heptan- | 15-25 | 15-25 | 15-25 |
| | 4-yl)silane | | | |
| | [Diacetyloxy(propyl)silyl] | 15-25 | 15-25 | 15-25 |

A bio-based oil was then added to each one of the above bases in the amounts shown in table 2, and thoroughly mixed for about 30-60 minutes to obtain a uniform distribution uniform, stable oil-based composition. The resulting mix was then optionally homogenized using a high shear mixer at 3000-5000 rpm for about 30-60 minutes to obtain a homogeneous composition.

TABLE 2

| | | No. 1 | No. 2 | No. 3 |
|---|---|---|---|---|
| Ingredient | Example | wt. % | wt. % | wt. % |
| Bio-based | Soy methyl ester | 20 | 35 | 50 |
| oil | | | | |

The resulting compositions had moderate viscosity allowing for easy application by spraying or brushing. The nanoparticles were evenly dispersed throughout the solution, providing uniform coverage and functionality.

Resulting composition No. 1 was sprayed onto asphalt-containing shingles having a low age deterioration (e.g., newer looking shingles), and resulted in successful rejuvenation and provided additional protection, while preserving aesthetics, such as color and texture. Resulting composition No. 2 was sprayed onto asphalt-containing shingles having a moderate age deterioration, and resulted in successful rejuvenation and provided additional protection, while preserving aesthetics, such as color and texture. Resulting composition No. 3 was sprayed onto asphalt-containing shingles having a heavy age deterioration, and resulted in successful rejuvenation and provided additional protection, while preserving aesthetics, such as color and texture.

Similar results were obtained with treatment of new looking, moderately aged, and heavily aged roof membranes.

### Example 2

In this example, Fourier Transform Infrared Spectroscopy is used to analyze an asphalt- containing shingle treated with a base containing an organic solvent and organosilicon nanoparticles.

Infrared (IR) spectra were obtained with a Nicolet™ FTIR spectrometer (Thermo Scientific™) equipped with a deuterated triglycine sulfate (DTGS) detector and an iS5 Attenuated Total Reflectance (ATR) unit. The FTIR analysis parameters to obtain the IR spectra performed on the samples were 32 scans per spectrum at a resolution of 4 cm⁻¹. The IR spectra (measured in absorbance) were obtained at wavelengths between 400 and 4000 cm⁻¹ (mid-IR). The IR spectra were recorded with OMNIC (Thermo Scientific™ Software). For each sample, 6 spectra were performed and an average spectrum was produced and considered representative of each sample.

FIG. 5 shows the FITR spectrum of the base containing organosilicon nanoparticles set forth in Table 1. The peaks (absorption bands) of the spectrum which lie in the region 2950-2850 cm⁻¹ correspond to the C-H of the alkane groups. The absorption bands between 1770-1725 cm⁻¹ and 1260-1195 cm⁻¹ correspond to the ester groups (Si—O—CO—CH₃). The band in the 1200-1110 cm⁻¹ and 900 cm⁻¹ regions corresponds to alkoxyl groups (Si—ORx), being R alkyl groups (—CH). The absorption bands between 780-760 cm⁻¹ correspond to polysilanes (O—Si—(CH₃)x). The functional groups identified by FTIR are consistent with the organosilicon nanoparticles set forth in Table 1.

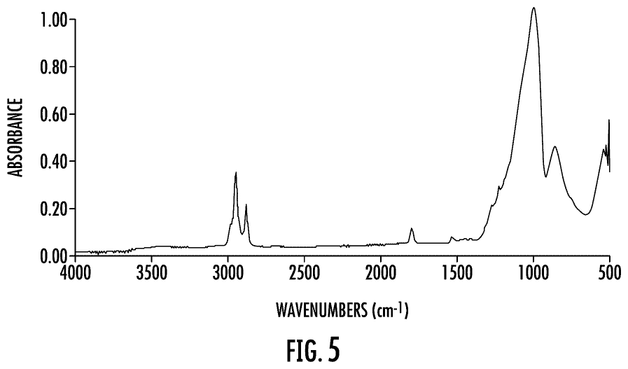

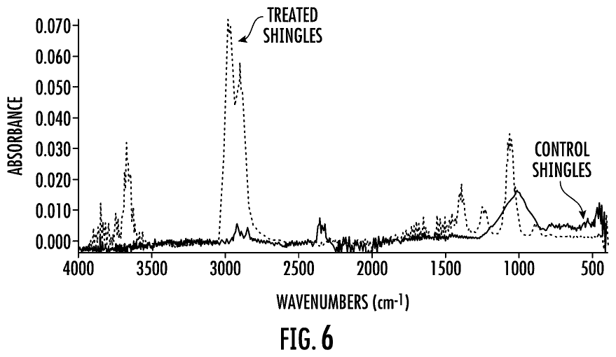

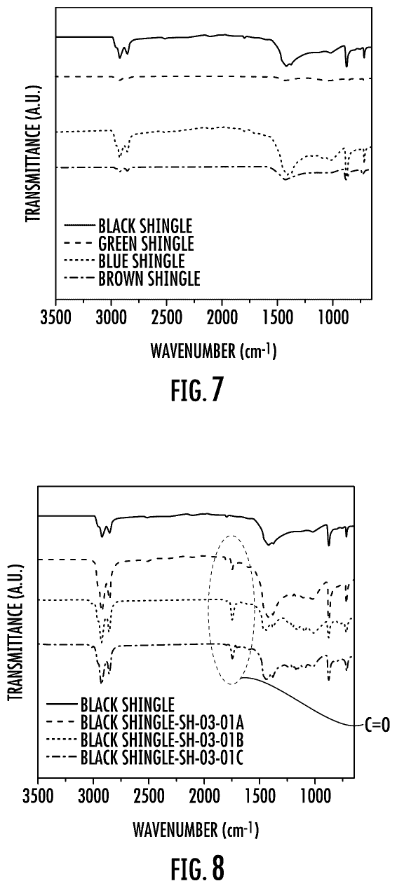

FIG. 6 shows the FITR spectrum of an asphalt-containing shingle treated with the base containing organosilicon nanoparticles set forth in Table 1 (“treated shingle”) and of a non- treated asphalt-containing shingle (“control shingle”). For the control shingle, the intensity of the IR spectrum is low. For this sample, groups characteristic of organic compounds were identified. Specifically, the IR bands in the region 2960-2850 cm⁻¹ would correspond to the alkyl bonds (C—H), and from 1260-1000 cm⁻¹ to the alkoxyl group (C—O). For the treated shingle, there is an appearance of functional groups specific to organosilicon compounds, such as the products shown in Table 1. More precisely, several infrared bands specific to silanes have been identified: infrared bands of the region 3700-3690 cm⁻¹ and 950-810 cm⁻¹ corresponding to the Si—OH group of silica; the infrared band between 1770-1725 cm⁻¹ (slightly marked) and 1260-1195 cm⁻¹ corresponding to acetoxy groups (C═O bonds of ester groups); the infrared bands 1385-1370 cm⁻¹ and 1055-1030 cm⁻¹ corresponding to the Si-alkoxy groups (Si—OCH(CH₃)₂); those between 1260-1220 cm⁻¹ corresponding to Si—CH₂CH₃ bonds; and the region 1220-1170 cm⁻¹ corresponding to the alkyl groups (Si—CH₂(CH₂)xCH₃).

Similar results were obtained with SBS modified asphalt-containing shingles treated with the base containing organosilicon nanoparticles set forth in Table 1.

These results demonstrate that the treatment of asphalt-containing shingles with a base containing an organic solvent and organosilicon nanoparticles causes the presence of functional groups present in the nanoparticles at the surface of the shingles, suggesting that new bonds are created at the surface between the nanoparticles and the shingles and/or that the nanoparticles incorporate within the structure of the shingles. In other words, the surface of the shingles has been modified.

### Example 3

In this example, a composition containing an organic solvent and organosilicon nanoparticles was used to treat an unrated shingle.

After a single treatment of an unrated asphalt-containing shingle with the composition, resulted in granular loss which was reduced by 12%. A second application further enhanced the reduction, achieving a 14% improvement in granular loss. The tear score of the unrated shingles improved by 10% after one treatment. A subsequent treatment provided a cumulative improvement of 18% in tear resistance.

### Example 4

In this example, a plurality of compositions were made, including control compositions and compositions that include organosilicon nanoparticles and a bio-based oil.

Composition 1 was made as follows: Add 50 mL of SoyGold 1000 to a 250 ml beaker with a magnetic stir bar. Add 50 mL of hydrotreated light distillate (kerosene) into the beaker while maintaining constant stirring at 150 RPM until homogeneous. This composition thus includes an organic solvent and a bio-based oil.

Composition 2 was made as follows: Add 50 mL of SoyGold 1000 to a 250 ml beaker with a magnetic stir bar. Add 50 mL of a base containing 40 w. % hydrotreated light distillate and 60 wt. % nanoparticles into the beaker while maintaining constant stirring at 150 RPM until homogeneous. This composition thus includes an organic solvent, a bio-based oil and nanoparticles.

Composition 3 was made as follows: Add 40 mL of SoyGold 1000 to a 250 ml beaker with a magnetic stir bar. Gradually add 20 grams of Gilsonite into the beaker while maintaining constant stirring at 150 RPM until homogeneous. Slowly add 40 mL of a base containing 40 w. % hydrotreated light distillate and 60 wt. % nanoparticles into the beaker while maintaining constant stirring at 150 RPM. This composition thus includes an organic solvent, a bio-based oil, Gilsonite and nanoparticles.

Composition 4 was made as follows: 100 ml of a base containing 40 wt. % hydrotreated light distillate and 60 wt. % nanoparticles were mixed at 500 RPM for 30-60 minutes. This composition thus includes an organic solvent and nanoparticles.

Composition 5 was made as follows: Add 20 ml of SoyGold 1000 to a 400 ml beaker with a magnetic stir bar. Add 80 mL of a base containing 40 wt. % hydrotreated light distillate and 60 wt. % nanoparticles into the beaker while maintaining constant stirring at 150 RPM until homogeneous. This composition thus includes a base, a bio-based oil and nanoparticles.

Composition 6 was made as follows: Add 20 mL of SoyGold 1000 to a 400 ml beaker with a magnetic stir bar. Gradually add 10 grams of Gilsonite into the beaker while maintaining constant stirring at 150 RPM. Slowly add 70 mL of a base containing 40 wt. % hydrotreated light distillate and 60 wt. % nanoparticles into the beaker while maintaining constant stirring at 150 RPM. This composition thus includes a base, a bio-based oil, Gilsonite and nanoparticles.

### Example 5

This example describes an impact-test for testing shingles.

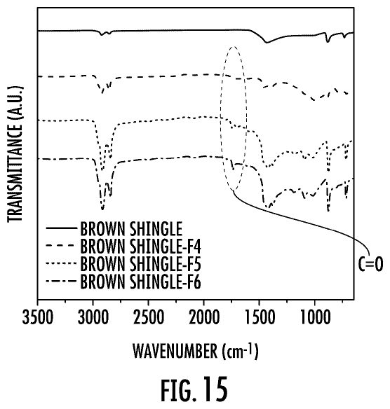

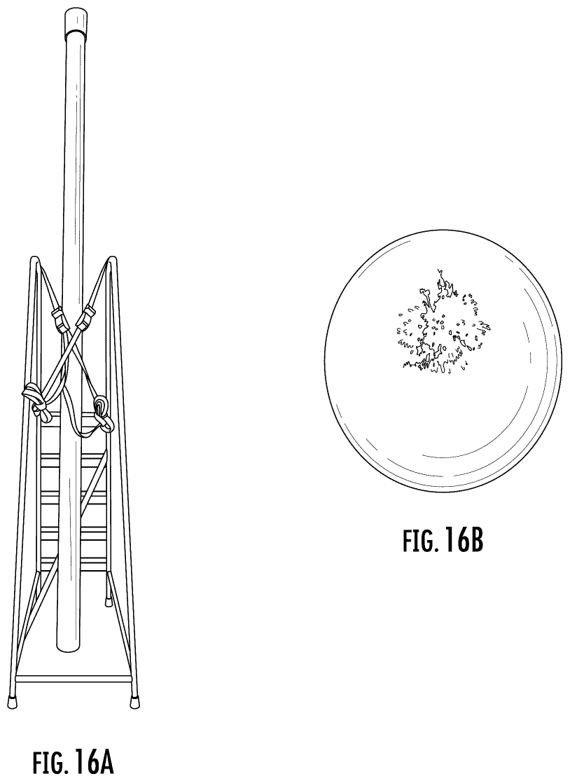

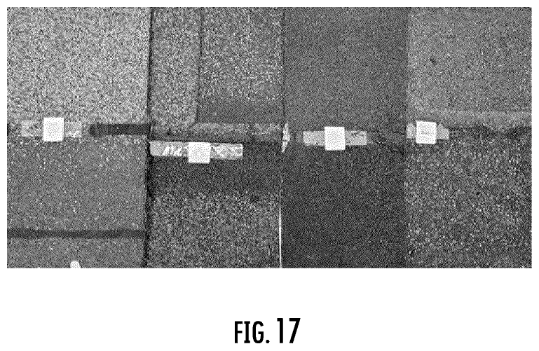

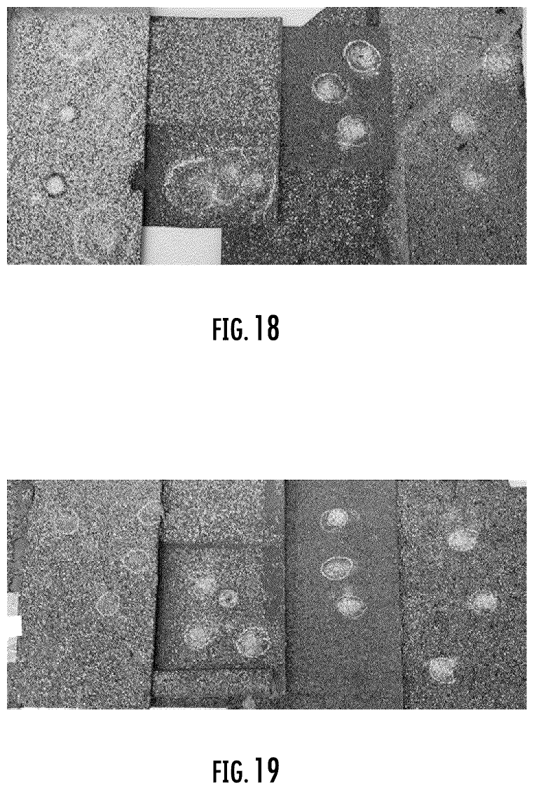

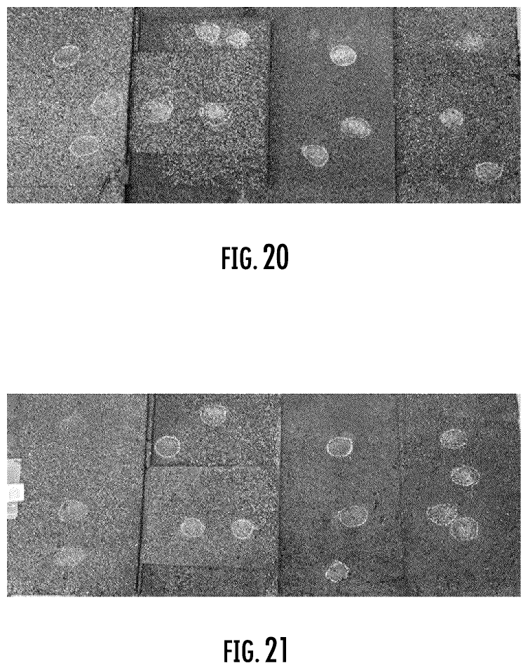

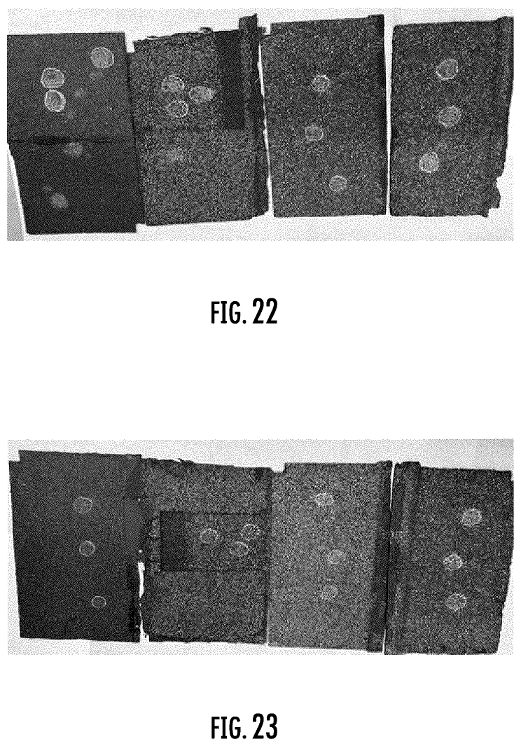

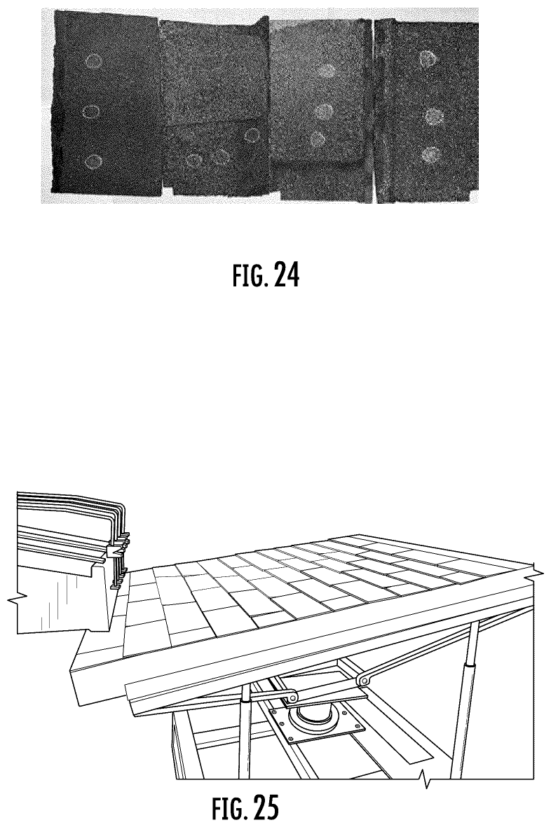

The impact test was performed as follows. A 3 inch ball (hard wear-resistant 52100 alloy steel balls—1.8 Kg) was dropped from a 10 feet long PVC pipe onto a shingle, which was placed on top of a piece of wood laying on the floor. A picture of the shingles before and after each impact was taken. The ball was dropped on the shingle 3 times, in different areas. 24 samples were tested, in total (4 shingles, 6 compositions each+control). A picture of the set up is shown in FIG. 16A, and of the ball in FIG. 16B. The depth of the ball impact on the shingle is characterized with a scale of from 0 to 3, where 0 represents no indentation on the shingle material, 1 represents a slight indentation, and 3 represents the deepest indentation.

The energy of the ball when it hit the surface was calculated with the following equation: E=1/2mv²=mgh, where m is the mass in kilograms, g is the acceleration due to gravity (9.8 m/s² at the surface of the earth) and h is the height in meters. The ball mass was 1.8 kg. Only the areas on top were used for the test (the areas that are exposed to air/rain/sunlight).

TABLE 3

| | |
|---|---|
| Height | Energy |

| | | |
|---|---|---|
| 3.048 m | (10 ft) | 53.8 J |
| 1.524 m | (5 ft) | 26.9 J |
| 0.762 | (2.5 ft) | 13.5 J |
| 0.457 m | (1.5 ft) | 8.1 J |
| 0.305 m | (1 ft) | 5.4 J |

Table 4 compares the energy obtained in the present test and in ASTM (ASTM stands for “American Society for Testing and Materials” which is a developer of international voluntary consensus standards), FM (FM approvals is the independent testing arm of international insurance carrier, FM Global.) and UL ((UL standard is a published set of best practices for manufacturing and testing the safety, security, and sustainability of a product or system) standard tests:

TABLE 4

| Standard | Diameter | | Mass | | Distance | | Energy |
|---|---|---|---|---|---|---|---|
| ASTM D 3746 | 2″ | (50 mm) | 2.27 lbs | (kg) | 4′5.0″ | (1355 mm) | 30.0 J |
| FM Class I-SH | 1.75″ | (45 mm) | 0.360 lbs | (kg) | 17′9.5″ | (5400 mm) | 19.0 J |
| FM Class I-MH | 2″ | (51 mm) | 0.737 lbs | (kg) | 5′ | (1500 mm) | 10.8 J |
| UL Class 1 | 1.25″ | (32 mm) | 0.28 lbs | (0.127 kg) | 12′ | (3700 mm) | 4.6 J |
| UL Class 2 | 1.5″ | (38 mm) | 0.48 lbs | (0.218 kg) | 15′ | (4600 mm) | 9.8 J |
| UL Class 3 | 1.75″ | (46 mm) | 0.79 lbs | (0.358 kg) | 17′ | (5200 mm) | 18.3 J |
| UL Class 4 | 2″ | (51 mm) | 1.15 lbs | (0.521 kg) | 20′ | (6100 mm) | 31.2 J |
| Present Test | 3″ | (76 mm) | 3.9 lbs | (1.8 Kg) | 10′ | (3050 mm) | 53.8 J |

Table 5 provides Terminal Velocities and Energies of Hailstones.

TABLE 5

| Diameter | Terminal Velocity | Approximate Impact Energy | |
|---|---|---|---|
| 1 in (2.5 cm) | 73 ft/s, 50 mi/hr (22.3 m/s) | <1 ft · lbs | (<1.36 Joules) |
| 1-¼ in (3.2 cm) | 82 ft/s, 56 mi/hr (25.0 m/s) | 4 ft · lbs | (5.42 Joules) |
| 1-½ in (3.8 cm) | 90 ft/s, 61 mi/hr (27.4 m/s) | 8 ft · lbs | (10.85 Joules) |
| 1-¾ in (4.5 cm) | 97 ft/s, 66 mi/hr (29.6 m/s) | 14 ft · lbs | (18.96 Joules) |
| 2 in (5.1 cm) | 105 ft/s, 72 mi/hr (32.0 m/s) | 22 ft · lbs | (29.80 Joules) |
| 2-½ in (6.4 cm) | 117 ft/s, 80 mi/hr (35.7 m/s) | 53 ft · lbs | (71.9 Joules) |
| 2-¾ in (7.0 cm) | 124 ft/s, 85 mi/hr (37.8 m/s) | 81 ft · lbs | (109.8 Joules) |
| 3 in (7.6 cm) | 130 ft/s, 88 mi/hr (39.6 m/s) | 120 ft · lbs | (162.7 Joules) |

### Example 6

In this example, various asphalt-containing shingles are tested in the impact test of Example 5. Shingles are treated with a composition from Example 4 or are not-treated (control).

Four shingles were tested: Architectural shingle (˜12 years old, blue), 3-tab shingle (˜14-16 years old, brown), 3-tab shingles (new, black), and 3-tab shingle (˜4-5 years old, green). Compositions 1 and 2 were applied with a handheld garden pump sprayer (Vivosun, 0.2 gallon). Composition 3 was applied with a soft paint brush. The treated shingles were air dried at room temperature for 24 hours, before they were taken for FTIR measurements. About 15 g of formulation was applied to 1 ft2 of each shingle.

Table 6 provides the impact test results for the black shingle (new):

TABLE 6

| | Average diameter | |
|---|---|---|
| Black shingle | (cm) | Depth |
| Control | 2.7 | 1, 1, 2 |
| Composition 1 | 2.5 | 1, 1, 1 |
| Composition 2 | 2.7 | 2, 2, 2 |
| Composition 3 | 2.3 | 0, 0, 1 |
| Composition 4 | 3.0 | 1, 1, 1 |
| Composition 5 | 2.3 | 0, 0, 0 |
| Composition 6 | 2.3 | 0, 0, 0 |

Compositions 5 and 6 stand out as having the higher impact resistance when considering both indentation diameter and depth.

Table 7 provides the impact test results for the Green shingle (about 4-5 years old).

TABLE 7

| | Average diameter | |
|---|---|---|
| Green shingle | (cm) | Depth |
| Control | 2.6 | 1, 1, 1 |
| Composition 1 | 2.7 | 1, 1, 2 |
| Composition 2 | 3.0 | 1, 1, 2 |
| Composition 3 | 2.4 | 0, 0, 1 |
| Composition 4 | 2.4 | 1, 0, 1 |
| Composition 5 | 2.2 | 0, 0, 0 |
| Composition 6 | 2.5 | 0, 0, 0 |

Compositions 5 and 6 stand out as having the higher impact resistance when considering indentation depth for Green shingle (about 3-4 years old).

Table 8 provides the impact test results for the blue shingle (about 12 years old).

TABLE 8

| | Average diameter | |
|---|---|---|
| Blue shingle | (cm) | Depth |
| Control | 2.4 | 3, 3, 2 |
| Composition 1 | 3.0 | 2, 2, 2 |
| Composition 2 | 2.6 | 1, 1, 2 |
| Composition 3 | 2.5 | 1, 1, 2 |
| Composition 4 | 2.7 | 1, 2, 3 |
| Composition 5 | 2.5 | 0, 1, 0 |
| Composition 6 | 2.4 | 0, 1, 0 |

Compositions 5 and 6 stand out as having the higher impact resistance when considering indentation depth for blue shingle (about 12 years old).

Table 9 provides the impact test results for the brown shingle (about 14-16 year old shingle).

TABLE 9

| | Average diameter | |
|---|---|---|
| Brown shingle | (cm) | Depth |
| Control | 2.9 | 3 (crack), |
| | | 2, 3 (crack) |
| Composition 1 | 3.0 | 2, 2, 2 |
| Composition 2 | 2.6 | 1, 1, 1 |
| Composition 3 | 2.9 | 1, 1, 1 |
| Composition 4 | 3.0 | 1, 1, |
| | | 3 (crack) |
| Composition 5 | 2.5 | 1, 1, 1 |
| Composition 6 | 2.7 | 0, 1, 1 |

Composition 6 stands out as having the highest impact resistance when considering indentation depth for brown shingle (about 14-16 years old).

Overall, compositions 5 and 6 demonstrated better performance on the impact test for all shingles samples (old and new).

### Example 7

In this example, a roofing wind test was performed on asphalt shingles treated with a composition containing an organic solvent and nanoparticles.

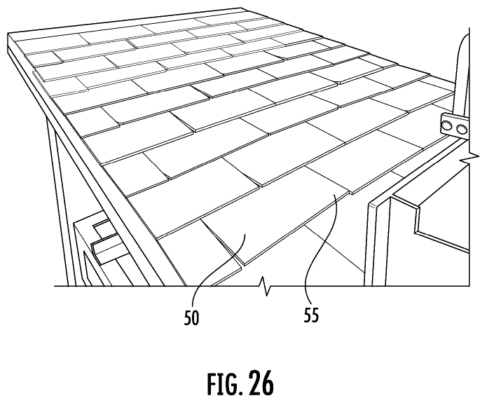

The tests were performed using ASTM D3161/D3161M—Standard Test Method for Wind- Resistance of Steep Slope Roofing Products (Fan-Induced Method), Revised May 1, 2020, with wind velocities of from about 90 mph to about 110 mph, for 120 minutes. The test set up is illustrated in FIGS. 25-26. Shingles were mechanically fastened to an underlayment of one ply wood and the shingles were treated with a single application of the composition. The ambient room temperature during construction of the test roof was maintained between 65-95° F. (18-35° C.), the panel conditioning was maintained at 135-140° F. (57-60° C.) during 16 continuous hours, and the ambient room temperature was maintained between 70-80° F. (21-26° C.) during the test.

A roofing wind test at either 90 mph (FIG. 25) or 110 mph (FIG. 26) for 120 minutes resulted in no evidence of permanent damage (such as creasing, tearing, cracking, or splitting). During the tests, some shingles 50 had at least a portion of a bottom half thereof 55 lift off from the underlayment due to wind velocity-such shingles returned to the initial position and state after the test concluded, which is indicative that the treated shingles had a restored flexibility (capable of bending under the wind and returning to initial configuration once the wind ceases) while being resistant to creasing, tearing, cracking, or splitting.

### Example 8

In this example, a shingle was treated with a composition from Example 4, containing soybean oil in a 20:80 or 50:50 ratio.

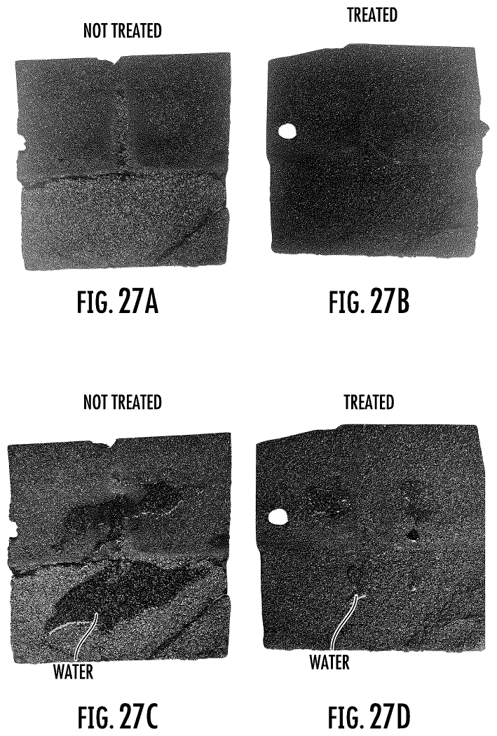

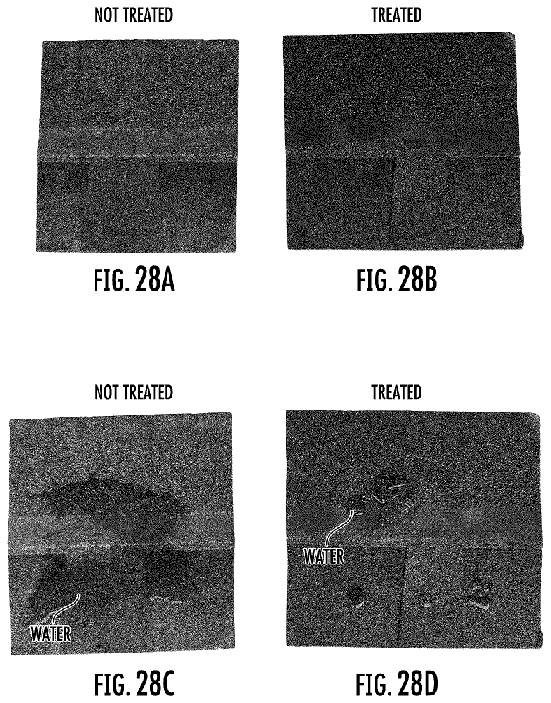

FIGS. 27A-27D relate to a water spill test with a 15 year old shingle treated with composition 1 (ratio 50:50) and FIGS. 28A-28D relate to a water spill test with a new shingle treated with composition 5 (ratio 20:80).

The water spill test includes adding a volume of water over a shingle and taking a picture thereof to assess the effect of treating the shingle with a composition over the ability of the shingle to absorb moisture (which is undesired) or repel moisture (desired). Moisture repelling capability is determined with formation of water “beads” over the surface of the shingle, which is indicative of surface hydrophobicity. The present inventor has found that applying composition as per the present disclosure to at least the upper surface (i.e., top) of the shingle prohibits moisture from infiltrating the shingle surface, thus preventing water-associated damage. As illustrated in FIG. 28D, when the moisture contacts the upper surface of the treated shingle, the moisture will “bead” up and prohibit moisture from infiltrating the shingle surface in contrast to the untreated shingle in FIG. 28C. Such a water repelling effect is stronger with composition 5 (FIG. 28D) than with composition 1 (FIG. 27D) demonstrating the synergistic effect of organosilicon nanoparticles with soybean oil.

### Example 9

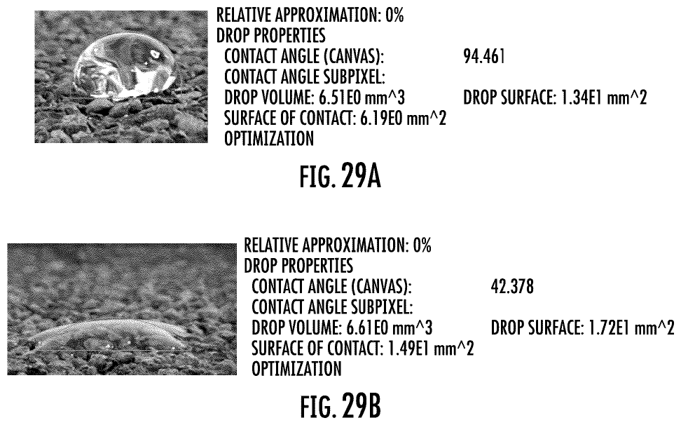

FIGS. 29A-29B are non-limiting pictures a new control shingle and of similar new shingle treated with a composition containing a 20:80 mixture of the soybean oil and base.

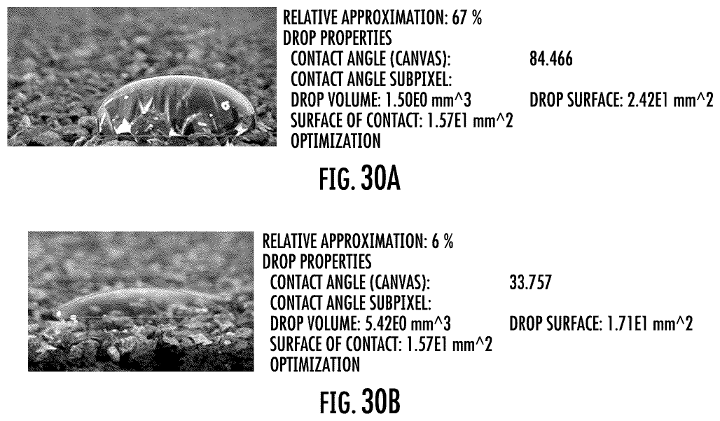

FIGS. 30A-30B are non-limiting pictures of an old control shingle and of similar old shingle treated with a composition containing a 50:50 mixture of the base and soybean oil.

Other examples of implementations will become apparent to the reader in view of the teachings of the present description and as such, will not be further described here.

All references cited throughout the specification are hereby incorporated by reference in their entirety for all purposes.

Note that titles or subtitles may be used throughout the present disclosure for convenience of a reader, but in no way these should limit the scope of the invention. Moreover, certain theories may be proposed and disclosed herein; however, in no way they, whether they are right or wrong, should limit the scope of the invention so long as the invention is practiced according to the present disclosure without regard for any particular theory or scheme of action.

As used herein, the wording “independently selected” in reference to a group of specified items refers to the fact that when more than one item is selected from the group of items, the decision of selecting a specific item is not influenced by the decision of selecting any of the previous or following item(s).

Reference throughout the specification to “some embodiments”, and so forth, means that a particular element (e.g., feature, structure, and/or characteristic) described in connection with the invention is included in at least one embodiment described herein, and may or may not be present in other embodiments. In addition, it is to be understood that the described inventive features may be combined in any suitable manner in the various embodiments.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control.

As used in the present disclosure, when the terms “around”, “about” or “approximately” are before a quantitative value, the present disclosure also includes the specific quantitative value itself, unless specifically stated otherwise. As used herein, the terms “around”, “about” or “approximately” refer to a ±10% variation from the nominal value unless otherwise indicated or inferred.

Unless otherwise noted, the expression “at least” or “at least one of” as used herein includes individually each of the recited objects after the expression and the various combinations of two or more of the recited objects unless otherwise understood from the context and use. The expression “and/or” in connection with three or more recited objects should be understood to have the same meaning unless otherwise understood from the context.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

Unless otherwise noted, the order of steps or order for performing certain actions is immaterial so long as the present invention remain operable. Moreover, two or more steps or actions may be conducted simultaneously.

Unless otherwise noted, the use of any and all examples, or exemplary language herein, for example, “such as” or “including,” is intended merely to better illustrate the present invention and does not pose a limitation on the scope of the invention. No language in the specification should be construed as indicating any non-claimed element as essential to the practice of the present invention.

Although various embodiments of the disclosure have been described and illustrated, it will be apparent to those skilled in the art considering the present description that numerous modifications and variations can be made. The scope of the invention is defined more particularly in the appended claims.

1. A composition for preventing and/or reversing age-associated damage to a building covering material, comprising
a base including an organic solvent and nanoparticles, and
a bio-based oil,
wherein the composition includes an amount of the bio-based oil and of the base in a wt.: wt. ratio of from about 20:80 to about 50:50, and wherein the composition is adapted for application on a surface of the building covering material.

2. The composition of claim 1, wherein the bio-based oil has high flash point temperature 93° C., as determined by ASTM D92-05a.

3. The composition of claim 1, wherein the organic solvent includes hydrotreated light distillate.

4. The composition of claim 1, wherein the bio-based oil is linseed oil, olive oil, peanut oil, corn oil, palm oil, canola oil, soybean oil, tall oil, or a blend thereof.

5. The composition of claim 1, wherein the bio-based oil is soybean oil.

6. The composition of claim 1, wherein the bio-based oil includes soy methyl ester.

7. The composition of claim 1, wherein the nanoparticles have an average particle size of from about 10 nm to about 100 nm.

8. The composition of claim 1, wherein the building covering material includes a shingle or roof membrane.

9. The composition of claim 1, wherein the nanoparticles include nano-silica, nano-titania, carbon nanotubes, organosilicon nanoparticles, nanoclay, graphene oxide, nano-alumina particles, or any mixture thereof.

10. The composition of claim 9, wherein the nanoparticles are organosilicon nanoparticles.

11. The composition of claim 1, wherein the composition includes an amount of nanoparticles of from about 5 wt. % to about 25 wt. %.

12. The composition of claim 1, wherein the nanoparticles are:
a) octamethylcyclotetrasiloxane,
b) trimethoxyoctylsilane,
c) (7-oxabicyclo[4.1.0]heptan-4-yl) silane,
d) [diacetyloxy(propyl)silyl], or
e) any mixtures thereof.

13.-34. (canceled)

35. The composition of claim 1, wherein the organic solvent is hydrotreated light distillate, the nanoparticles are organosilicon nanoparticles, and the bio-based oil is soy methyl ester.

36. The composition of claim 35, wherein the organosilicon nanoparticles include
a) octamethylcyclotetrasiloxane,
b) trimethoxyoctylsilane,
c) (7-oxabicyclo[4.1.0]heptan-4-yl) silane,
d) [diacetyloxy(propyl)silyl], or
e) any mixtures thereof.
